(19) United States
(12) Patent Application Publication
(10) Pub. No.: US 2004/0224202 A1
(43) Pub. Date: Nov. 11, 2004

(54) Ion-exchange materials

(76) Inventors: Richard F Bridges, Poulton Le Fylde (GB); Peter Charnock, Poulton Le Fylde (GB); David J Kemmish, Preston (GB); Brian Wilson, Gerstang (GB)

Correspondence Address: Nixon & Vanderhye, 1100 North Glebe Road, 8th Floor, Arlington, VA, 22201-4714, US

(21) Appl. No.: 10/239,144

(22) PCT Filed: Mar. 21, 2001
(86) PCT No.: PCT/GB01/01232

(30) Foreign Application Priority Data
Mar. 22, 2000 (GB) 0006880.9
Dec. 21, 2000 (GB) 0031208.2

(51) Int. Cl. H01M 8/10; H01M 4/86; C08J 5/22

(52) U.S. Cl. 429/30; 521/27; 429/42; 429/33

(57) ABSTRACT

An ion-exchange material, for example a polymer electrolyte membrane or gas diffusion electrode comprises a semi-crystalline copolymer comprising: a first unit which includes an ion-exchange site; a second crystalline unit; and a third unit which is amorphous. The third unit is used to disrupt the crystallinity of the copolymer thereby to increase its solubility in solvents. The material described may be used in fuel cells.

This invention relates to an ion-exchange materials (e.g. polymer electrolyte membranes) and particularly, although not exclusively, relates to a method of preparing an ion-exchange membrane and such a membrane per se.

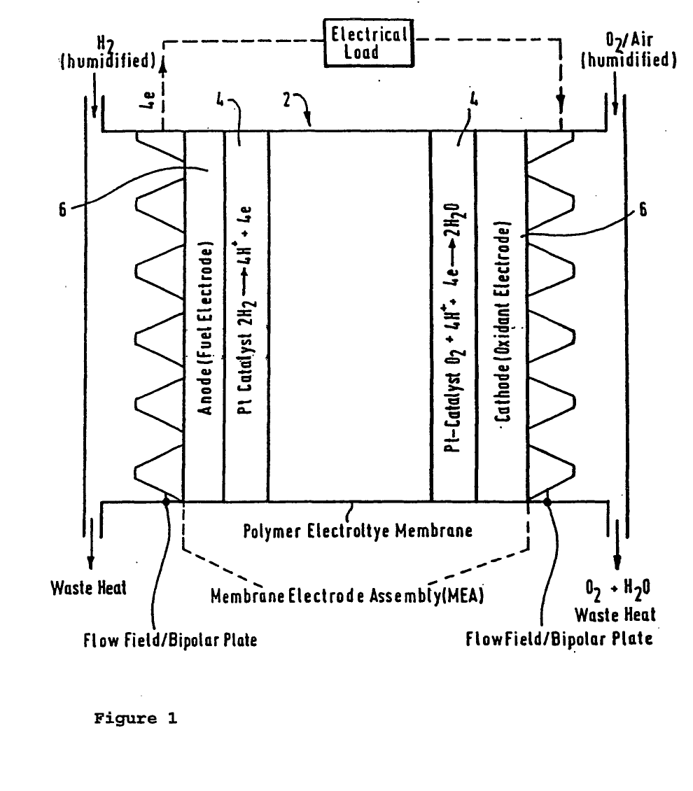

One type of polymer electrolyte membrane fuel cell (PEMFC), shown schematically in FIG. 1 of the accompanying diagrammatic drawings, may comprise a thin sheet 2 of a hydrogen-ion conducting Polymer Electrolyte Membrane (PEM) sandwiched on both sides by a layer 4 of platinum catalyst and an electrode 6. The layers 2, 4, 6 make up a Membrane Electrode Assembly (MEA) of less than 1 mm thickness.

In a PEMFC, hydrogen is introduced at the anode (fuel electrode) which results in the following electrochemical reaction:

Pt-Anode (Fuel Electrode) 2H₂→4H⁺4e⁻

The hydrogen ions migrate through the conducting PEM to the cathode. Simultaneously, an oxidant is introduced at the cathode (oxidant electrode) where the following electrochemical reaction takes place:

Pt-Cathode (Oxidant Electrode) O₂+4H⁺4e⁻→2H₂O

Thus, electrons and protons are consumed to produce water and heat. Connecting the two electrodes through an external circuit causes an electrical current to flow in the circuit and withdraw electrical power from the cell.

Preferred ion-conducting polymeric materials for use as components of polymer electrolyte membranes in fuel cells have high conductivity (low EW, or high ion-exchange capacities), low water uptake, robustness and solubility in solvents which can be used to cast the membranes. However, some of the aforementioned requirements compete with one another. For example, steps taken to increase solubility of the materials in casting solvents may, disadvantageously, increase the water uptake of the materials; and steps taken to increase the conductivity of the materials will tend also to increase water absorption leading to premature failure of the materials when used in fuel cells.

It is an object of the present invention to address problems associated with the provision of polymer electrolyte membranes and/or gas diffusion electrodes.

The invention is based on the appreciation that copolymers comprising crystallisable units may be robust and provide membranes of low water absorption. Nonetheless, it has been appreciated that whilst the solubility of such copolymers in polar aprotic solvents (e.g. NMP) used to cast the membranes can be very low, the solubility can be increased by including a moiety in the copolymer which disrupts the crystallinity of the crystallisable unit, thereby reducing the crystallinity of the polymer. Nevertheless, whilst the crystallinity is reduced so that the copolymers have an increased solubility in polar aprotic solvents, the robustness and solubility in water are not significantly detrimentally affected.

According to a first aspect of the invention, there is provided a polymer electrolyte membrane or a gas diffusion electrode which include a semi-crystalline copolymer comprising:

a first unit which includes an ion-exchange site;

a second crystalline unit; and

a third unit which is amorphous.

The existence and/or extent of crystallinity in a polymer may be measured by wide angle X-ray diffraction (also referred to as Wide Angle X-ray Scattering or WAXS), for example as described by Blundell and Osborn (Polymer 24, 953, 1983). Details are provided in Example 8c hereinafter. Alternatively, crystallinity may be assessed by Differential Scanning Calorimetry (DSC)

The level of crystallinity (or “Crystallinity Index”) of said semi-crystalline copolymer, suitably measured as described above, may be at least 0.5%, is preferably at least 1%, is more preferably at least 3% and, especially is at least 5%. In some cases, the crystallinity may be greater than 10% or even greater than 12%. The crystallinity may be less than 20% or less than 15%.

Suitably, “A*” represents the mole % of said first unit in said copolymer; “B*” represents the mole % of said second unit; and “C*” represents the mole % of said third unit.

Suitably, A* is at least 15, preferably at least 20, more preferably at least 25, especially at least 30. It may be less than 70, preferably less than 60, more preferably less than 50. Preferably, A* is in the range 25-60.

B* may be at least 5. Suitably, B* is at least 15, preferably at least 25, more preferably at least 30, especially at least 35. It may be less than 70, preferably less than 60, more preferably less than 55. Preferably, B* is in the range 5-70.

Suitably, C* is at least 5, preferably at least 7.5, preferably at least 10, especially at least 12.5. In some 15 cases C* may be at least 25. C* may be less than 70, preferably less than 60, more preferably less than 55. In other cases,. C* may be less than 30, preferably less than 25, more preferably less than 20, especially 15 or less. Preferably, C* is in the range 5 to 70.

Said copolymer is preferably non-fluorinated.

Said first unit is preferably a repeat unit which suitably includes aromatic group containing moieties linked by —SO₂— and/or —CO— and/or -Q- groups, where Q is O or S. Because said first unit includes ion-exchange sites, for example, sulphonate groups, it will not be crystalline, but will be amorphous.

Said second unit is preferably a repeat unit which suitably includes aromatic group containing moieties linked by —CO— and/or -Q- groups, where Q is as described above. The second unit preferably does not include —SO₂— groups since such would tend to render the unit amorphous.

Said third unit is preferably a repeat unit which suitably includes aromatic group containing moieties linked by —SO₂ — and/or —CO— and/or -Q- groups, where Q is as described above provided, however, that said third unit suitably includes a means to render it amorphous (hereinafter said “amorphous means”) and/or not crystallisable with polyarylether ketones or polyarylthioether ketones and/or not crystallisable with the second unit described above.

Said third unit may comprise a fourth unit which is of formula -Q-Z-Q- wherein Z represents said aromatic group containing moiety, wherein said fourth unit is not symmetrical about an imaginary line which passes through the two -Q- moieties provided, however, that said fourth unit is not derived from dihydroxybenzophenone substituted by groups Q at the 4- and 4′-positions (since such a benzophenone acts in the manner of a symmetrical moiety by virtue of the carbonyl group being substantially similar to an ether group thereby allowing the carbonyl group to be interchanged with an ether group in a polyaryletherketone crystal lattice). Said third unit, for example moiety Z, may include a bulky group.

Said semi-crystalline copolymer may include a first unit which is of general formula

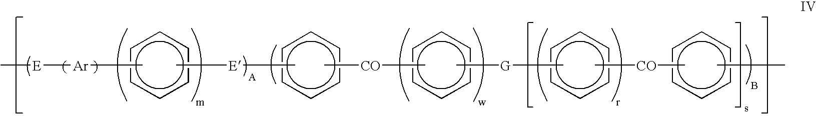

or of general formula

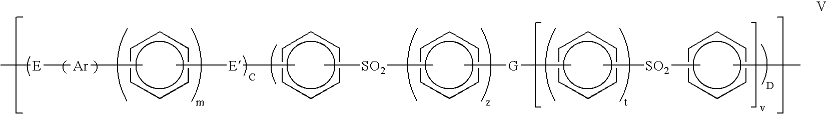

or of general formula

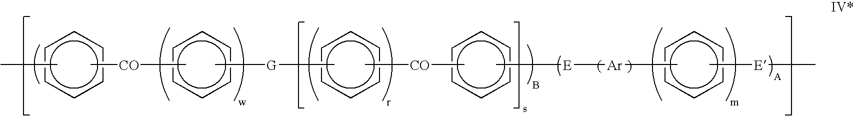

or of general formula

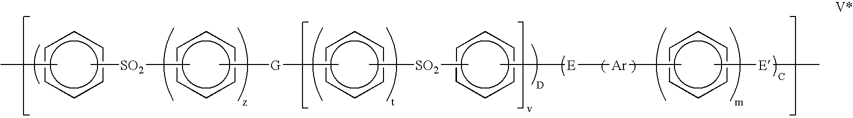

wherein said first unit is functionalised to provide ion-exchange sites; wherein the phenyl moieties in units IV, IV*, V and V* are independently optionally substituted wherein m,r,s,t,v,w and z independently represent zero or a positive integer, E and E′ independently represent an oxygen or a sulphur atom or a direct link, G represents an oxygen or sulphur atom, a direct link or a —O-Ph-O— moiety where Ph represents a phenyl group and Ar is selected from one of the following moieties (i)* and (i) to (x) which is bonded via one or more of its phenyl moieties to adjacent moieties

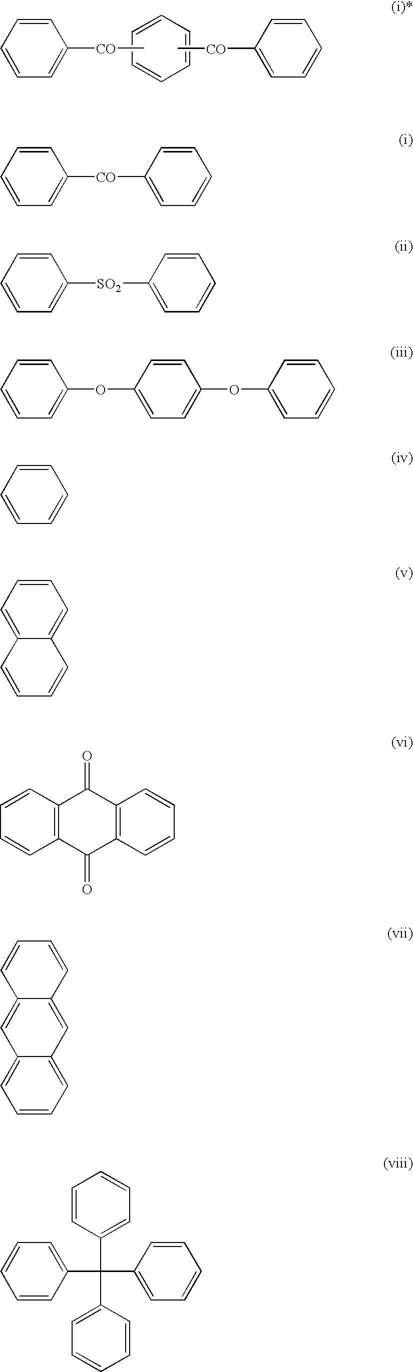

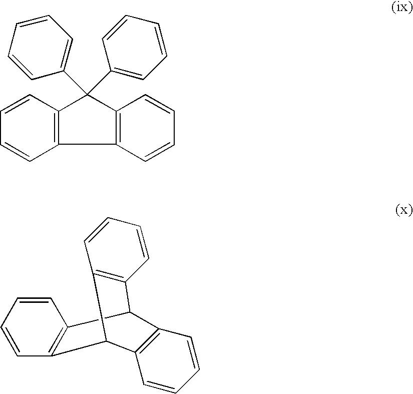

In (i)*, the middle phenyl may be 1,4- or 1,3-substituted.

Suitably, to provide said ion exchange sites, said copolymer is sulphonated, phosphorylated, carboxylated, quaternary-aminoalkylated or chloromethylated, and optionally further modified to yield —CH₂PO₃H₂, —CH₂NR₃²⁰⁺ where R²⁰ is an alkyl, or —CH₂NAr₃^{X+} where Ar^{x} is an aromatic (arene), to provide a cation or anion exchange membrane. Further still, the aromatic moiety may contain a hydroxyl group which can be readily elaborated by existing methods to generate —OSO₃H and —OPO₃H₂ cationic exchange sites on the polymer. Ion exchange sites of the type stated may be provided as described in WO95/08581.

Preferably, said first unit is sulphonated. Preferably, the only ion-exchange sites of the first unit are sites which are sulphonated.

References to sulphonation include a reference to substitution with a group —SO₃M wherein M stands for one or more elements selected with due consideration to ionic valencies from the following group: H, NR₄^{y+}, in which R^{y} stands for H, C₁-C₄ alkyl, or an alkali or alkaline earth metal or a metal of sub-group 8, preferably H, NR₄⁺, Na, K, Ca, Mg, Fe, and Pt. Preferably M represents H. Sulphonation of the type stated may be provided as described in WO96/29360.

Unless otherwise stated in this specification, a phenyl moiety may have 1,4- or 1,3- , especially 1,4- , linkages to moieties to which it is bonded.

Where a phenyl moiety described herein is optionally substituted, it may be optionally substituted by one or more halogen, especially fluorine and chlorine, atoms or alkyl, cycloalkyl or phenyl groups. Preferred alkyl groups are C₁₋₁₀, especially C₁₋₄, alkyl groups. Preferred cycloalkyl groups include cyclohexyl and multicyclic groups, for example adamantyl. In some cases, the optional substituents may be used in the cross-linking of the polymer. For example, hydrocarbon optional substituents may be functionalised, for example sulphonated, to allow a cross-linking reaction to take place. Preferably, said phenyl moieties are unsubstituted.

Another group of optional substituents of a phenyl moiety comprises alkyls, halogens, C_{y}F_{2y+1} where y is an integer greater than zero, O—R^{q} (where R^{q} is selected from the group consisting of alkyls, perfluoralkyls and aryls), CF═CF₂, CN, NO₂ and OH. Trifluormethylated phenyl moieties may be preferred in some circumstances.

Where w and/or z is/are greater than zero, the respective phenylene moieties may independently have 1,4- or 1,3-linkages to the other moieties in the repeat units of formulae II and/or III. Preferably, said phenylene moieties have 1,4-linkages.

Preferably, the polymeric chain of the copolymer does not include a —S— moiety. Preferably, G represents a direct link.

Preferably, m is in the range 0-3, more preferably 0-2, especially 0-1. Preferably, r is in the range 0-3, more preferably 0-2, especially 0-1. Preferably t is in the range 0-3, more preferably 0-2, especially 0-1. Preferably, s is 0 or 1. Preferably v is 0 or 1. Preferably, w is 0 or 1. Preferably z is 0 or 1

Preferably Ar is selected from the following moieties (xi)* and (xi) to (xxi):

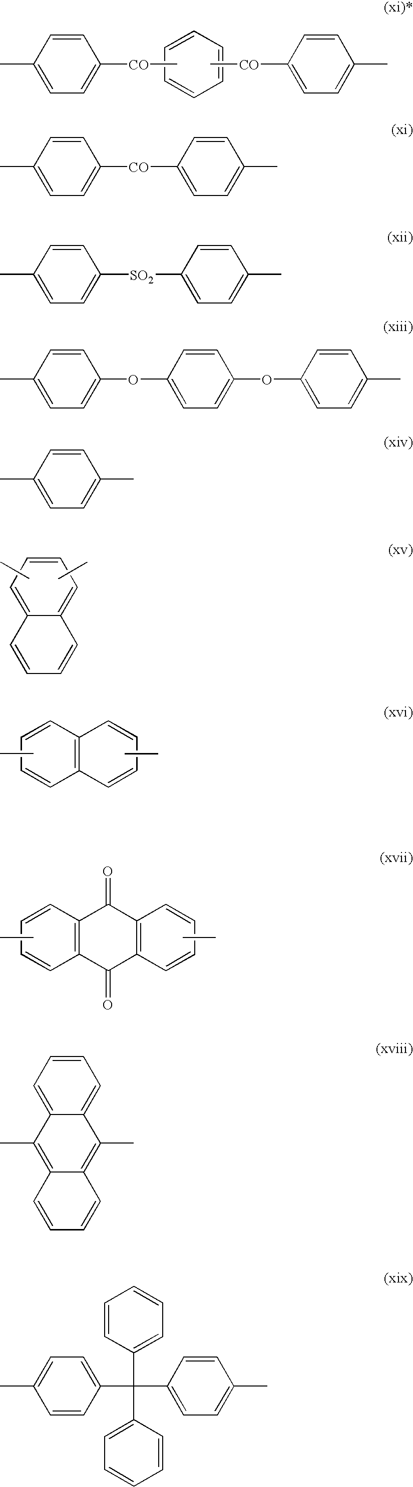

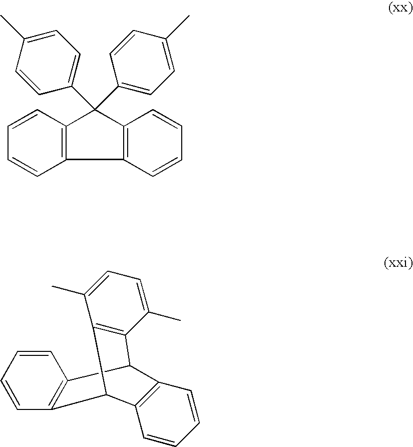

In (ix)*, the middle phenyl may be 1,4- or 1,3-substituted.

Preferably, (xv) is selected from a 1,2-, 1,3-, or a 1,5-moiety; (xvi) is selected from a 1,6-, 2,3-, 2,6- or a 2,7-moiety; and (xvii) is selected from a 1,2-, 1,4-, 1,5-, 1,8- or a 2,6-moiety.

A preferred first unit includes an electron-rich, relatively non-deactivated, easily sulphonatable unit, for example a multi-phenylene moiety or a fused-rings aromatic moiety, such as naphthalene. Such an easy to sulphonate unit may be sulphonated under relatively mild conditions to introduce two sulphonate groups per unit. Thus, preferred polymers may have at least 10π electrons in a delocalized aromatic moiety. The number of π electrons may be 12 or less. Preferred polymers include a biphenylene moiety. Other preferred polymers include a naphthalene moiety. Preferred polymers include said electron rich, non-deactivated, easily sulphonatable unit bonded to two oxygen atoms. Especially preferred polymers include a —O-biphenylene-O— moiety. Other especially preferred polymers include a —O-naphthalene-O— moiety.

Preferred first units include a first type of moiety which is relatively difficult to sulphonate and a second type of moiety which is relatively easy to sulphonate. For example, said second moiety may be sulphonatable using the relatively mild method described in Example 7 hereinafter, whereas the first moiety may be substantially non-sulphonatable in such a method. The use of the method of Example 7 may be advantageous over currently used methods which use oleum. A preferred second said moiety includes a moiety -Phₙ- wherein n is an integer of at least 2. Said moiety is preferably bound to at least one ether oxygen. Especially preferred is the case wherein said moiety is —O-Phₙ-O— where said ether groups are para to the Ph-Ph bond.

Said semi-crystalline polymer may include a second crystalline unit which is of general formula IV or IV* as described above, provided said unit is crystallisable. Suitably, to be crystallisable, said second unit does not include any Ar group of formula (ii) (viii), (ix) or (x). More preferably, it may also not include an Ar group of formula (v), (vi) or (vii). Preferred Ar groups consist of one or more phenyl groups in combination with one or more carbonyl and/or ether groups.

Said semi-crystalline polymer may include a third unit which is of general formula IV, IV*, V or V*, provided, however, that said unit includes at least some moieties whose shape and/or conformation is/are incompatible with the crystalline conformation of said second crystalline unit so that said third unit is amorphous. Preferably, said third unit includes an —SO₂— moiety; a bulky group or a moiety which is not symmetrical as described above.

Preferred first units may be -ether-phenyl-ketone-phenyl, -ether-phenyl-ketone-phenyl-ether-phenyl-ketone-phenyl-ketone-phenyl, -ether-biphenyl-ether-phenyl-ketone-phenyl, ether-phenyl-ether-phenyl-ketone-phenyl, ether-naphthalene-ether-phenyl-ketone-phenyl, ether-phenyl-ether-phenyl-ketone-phenyl-ketone-phenyl, -ether-dipheny-ether-phenyl-sulphone-phenyl- and -ether-phenyl-ether-phenyl-sulphone-phenyl, suitably functionalised with ion-exchange sites. Another preferred first unit is ether-phenyl-sulphone-phenyl. Preferred second units may be ether-phenyl-ketone-phenyl-ketone-phenyl-, ether-phenyl-ether-phenyl-ketone-phenyl-ketone-phenyl-, ether-phenyl-ether-phenyl-ketone-phenyl-, ether-phenyl-ketone-phenyl-, ether-phenyl-ketone-phenyl-ether-phenyl-ketone-phenyl-ketone-phenyl and ether-biphenyl-ether-phenyl-ketone-phenyl-. Preferred third units may be ether-phenyl-sulphone-phenyl and ether-phenyl-ether-phenyl-sulphone-phenyl. Another preferred third unit may be a -1,3- dioxy-4-(phenylcarbonyl) phenyl moiety derived from 2,4-DHB as herein defined.

In said copolymer, the mole % of co-monomer units, for example said first, second and third repeat units described above, may be varied to vary the solubility of the polymer in solvents, for example in solvents which may be used in the preparation of films and/or membranes from the polymers and/or in other solvents, especially water.

Preferred polymers suitably have a solubility of at least 4% w/w in a polar aprotic solvent, for example NMP, DMSO or DMF. Preferred polymers are substantially insoluble in boiling water.

Where a phenyl moiety is sulphonated, it may only be mono-sulphonated. However, in some situations it may be possible to effect bi- or multi-sulphonation.

In general terms, where a said copolymer includes a —O-phenyl-O— moiety, up to 100 mole % of the phenyl moieties may be sulphonated. Where a copolymer includes a —O-biphenylene-O— moiety, up to 100 mole % of the phenyl moieties may be sulphonated. It is believed to be possible to sulphonate relatively easily —O-(phenyl)ₙ-O— moieties wherein n is an integer, suitably 1-3, at up to 100 mole %. Moieties of formula —O-(phenyl)ₙ-CO— or —O-(phenyl)ₙ-SO₂— may also be sulphonated at up to 100 mole % but more vigorous conditions may be required. Moieties of formulae —CO-(phenyl)ₙ-CO— and —SO₂-(phenyl)ₙ-SO₂— are more difficult to sulphonate and may be sulphonated to a level less than 100 mole % or not at all under some sulphonation conditions.

The glass transition temperature (T_{g}) of said copolymer may be at least 144° C., suitably at least 150° C., preferably at least 154° C., more preferably at least 160° C., especially at least 164° C. In some cases, the Tg may be at least 170° C., or at least 190° C. or greater than 250° C. or even 300° C.

Said copolymer may have an inherent viscosity (IV) of at least 0.1, suitably at least 0.3, preferably at least 0.4, more preferably at least 0.6, especially at least 0.7 (which corresponds to a reduced viscosity (RV) of least 0.8) wherein RV is measured at 25° C. on a solution of the polymer in concentrated sulphuric acid of density 1.84 gcm³, said solution containing 1 g of polymer per 100 cm⁻³ of solution. IV is measured at 25° C. on a solution of polymer in concentrated sulphuric acid of density 1.84 gcm³, said solution containing 0.1 g of polymer per 100 cm³ of solution.

The measurements of both RV and IV both suitably employ a viscometer having a solvent flow time of approximately 2 minutes.

The main peak of the melting endotherm (Tm) for said polymer (if crystalline) may be at least 300° C.

In general terms, said polymer is preferably substantially stable when used as a PEM in a fuel cell. Thus, it suitably has high resistance to oxidation, reduction and hydrolysis and has very low permeability to reactants in the fuel cell. Preferably, however, it has a high proton conductivity. Furthermore, it suitably has high mechanical strength and is capable of being bonded to other components which make up a membrane electrode assembly.

Said polymer may comprise a film, suitably having a thickness of less than 1 mm, preferably less than 0.5 mm, more preferably less than 0.1 mm, especially less than 0.05 mm. The film may have a thickness of at least 5 μm.

Said polymer electrolyte membrane may comprise one or more layers wherein, suitably, at least one layer comprises a film of said polymer. Said membrane may have a thickness of at least 5 μm and, suitably, less than 1 mm, preferably less than 0.5 mm, more preferably less than 0.1 mm, especially less than 0.05 mm.

The polymer electrolyte membrane may be a composite membrane which may include a support material for the semi-crystalline copolymer for importing mechanical strength and dimensional stability to the membrane. The copolymer may be associated with the support material to form a composite membrane in a variety of ways. For example, an unsupported conductive polymer film of the copolymer can be preformed and laminated to the support material. Alternatively, (and preferably) the support material may be porous and a solution of the copolymer can be impregnated into the support material. In one embodiment, the support material may comprise, or preferably consist essentially of, polytetrafluoroethylene, suitably provided as a porous film. Such a support material may be as described and used in accordance with the teachings of WO97/25369 and WO96/28242, the contents of which are incorporated herein by reference. Suitably, the support material has a porous microstructure of polymeric fibrils and is impregnated with said copolymer throughout the material, preferably so as to render an interior volume of the membrane substantially occlusive.

In another embodiment, a porous support material may be provided by a fabric, for example of polyetheretherketone, which may have warp and weft strands or may comprise an irregular arrangement of fibres. Suitably, said pores are defined by the void volume of the fabric-that is between the fibres. However, the fibres of the fabric themselves may be porous and penetrated by said conductive polymer. Alternatively, a said porous support material may be microporous and may suitably be made by a phase inversion process. Such a microporous material preferably has no through pores and/or contains no closed pores. Further details on the porous support materials described may be found in PCT/GB00/03449, the contents of which are incorporated herein by reference.

In a further embodiment, said support material may comprise a conductive polymer as described in GB0006880.9, the contents of which are incorporated herein by reference. For example, said support material may comprise an ion-conducting microporous membrane.

Said semi-crystalline copolymer could be a component of a blend of polymers. In such a blend, said semi-crystalline copolymer preferably comprises at least 80%, more preferably at least 90 wt % thereof. Preferably, however, said semi-crystalline copolymer is not a component of a blend.

The polymer electrolyte membrane suitably includes a layer of a catalyst material, which may be a platinum catalyst (i.e. platinum containing) or a mixture of platinum and ruthenium, on both sides of the polymer film. Electrodes may be provided outside the catalyst material.

According to a second aspect of the invention, there is provided a fuel cell or an electrolyser (especially a fuel cell) incorporating a polymer electrolyte membrane according to the first aspect.

According to a third aspect of the invention, there is provided any novel polymer as described according to said first aspect per se.

According to a fourth aspect of the invention, there is provided a process for the preparation of a semi-crystalline polymer described in the first, second or third aspects, the process comprising polycondensing a compound of formula

X¹—BM-X² VI

with a compound of formula

Y¹—SU—Y² VII

and with a compound of formula

Y¹—XT-Y² VIII

and with a compound of formula

Z¹-AM-Z² IX

thereby to prepare a copolymer, wherein Y¹ represents a halogen atom or a group -EH (or -E′H if appropriate) and X¹ represents the other one of a halogen atom or group -EH (or -E′H if appropriate), Y² represents a halogen atom or a group -E′H and X² represents the other one of a halogen atom or a group -E′H (or -EH if appropriate) and Z¹ and Z² represent a halogen atom or a group -EH (or E′H if appropriate);

and wherein BM represents part of a base monomer, SU represents part of a moiety which is functionalised or can be functionalised (suitably independently of other moieties in the copolymer) to provide ion-exchange sites, XT represents a part of a crystalline or crystallisable moiety and AM represents part of an amorphous moiety.

The polycondensation reaction described is suitably carried out in the presence of a base, especially an alkali metal carbonate or bicarbonate or a mixture of such bases. Preferred bases for use in the reaction include sodium carbonate and potassium carbonate and mixtures of these.

The identity and/or properties of the polymers prepared in a polycondensation reaction described may be varied according to the reaction profile, the identity of the base used, the temperature of the polymerisation, the solvent(s) used and the time of the polymerisation. Also, the molecular weight of a polymer prepared controlled by using an excess of halogen or hydroxy reactants, the excess being, for example, in the range 0.1 to 5.0 mole %

In a polymer prepared in a said polycondensation reaction involving compounds of general formula VI, VII, VIII and IX, moieties of general formula VI, VII, VIII and IX (excluding end groups Y¹, Y², X¹, X², Z¹ and Z²) may be present in regular succession (that is, with single units of one said moiety, separated by single units of another said moiety or moieties), or semi-regular succession (that is, with single units of one said moiety separated by strings of another moiety or moieties which are not all of the same length) or in irregular succession (that is, with at least some multiple units of one moiety separated by strings of other moieties that may or may not be of equal lengths). The moieties described are suitably linked through ether or thioether groups.

Also, moieties in compounds VI, VII, VIII, and/or IX arranged between a pair of spaced apart —O— atoms and which include a -phenyl-SO₂ or -phenyl-CO— bonded to one of the —O— atoms may, in the polymer formed in the polycondensation reaction, be present in regular succession, semi-regular succession or in irregular succession, as described previously.

In any sampled polymer, the chains that make up the polymer may be equal or may differ in regularity from one another, either as a result of synthesis conditions or of deliberate blending of separately made batches of polymer.

In a first embodiment, where Z¹ and Z² in compound IX are the same as Y¹ and Y² respectively in other compounds used, the polycondensation of compounds VI, VII, VIII and IX may result in the preparation of a copolymer which includes units of formula

—BM-Q-SU-Q- X

—BM-Q-XT-Q- XI and

—BM-Q-AM-Q- XII

where Q is as described above.

In a second embodiment, where Z¹ and Z² in compound IX and X¹ and X² in compound VI are either all halogens (which may be all the same or the halogens may be different e.g. Z¹ and Z² could both be chlorine and X¹ and X² could both be fluorine) or all comprise a group -EH (or E¹H if appropriate), the polycondensation may result in the preparation of a copolymer which includes units of formula

—BM-Q-SU-Q- XX

—BM-Q-XT-Q- XXI

—XT-Q-AM-Q- XXII and

—SU-Q-AM-Q- XXIII

where Q is as described above.

In a third embodiment, a polycondensation may use two different compounds of formula IX. In one of the compounds Z¹ and Z² may be as described according to the first embodiment and in the other Z¹ and Z² may be as described according to the second embodiment and, therefore, a copolymer which includes units of formulae X, XI, XII, XXII XXIII and a unit -AM-Q-AM-Q- (where the AM moieties are the same or different) may be formed.

Whilst the moiety SU of monomer VII could be functionalised to provide ion-exchange sites, functionalisation is preferably undertaken after monomers VII and VI have been reacted, and suitably after said copolymer has been prepared. If, however, the moiety SU of monomer VII is sulphonated and then polymerized, there may be no need to sulphonate the copolymer formed. In this case, XT may include moieties which would sulphonate (e.g. easy to sulphate units such as biphenyl) if the copolymer itself was sulphonated.

Preferably, ion-exchange sites are provided by sulphonation.

Sulphonation as described herein may be carried out in concentrated sulphuric acid (suitably at least 96% w/w, preferably at least 97% w/w, more preferably at least 98% w/w; and preferably less than 98.5% w/w) at an elevated temperature. For example, dried copolymer may be contacted with sulphuric acid and heated with stirring at a temperature of greater than 40° C., preferably greater than 55° C., for at least one hour, preferably at least two hours, more preferably about three hours. The desired product may be caused to precipitate, suitably by contact with cooled water, and isolated by standard techniques. Sulphonation may also be effected as described in U.S. Pat. No. 5,362,836 and/or EP0041780.

Suitably, “a*” represents the mole % of compound VI used in the process; “b*” represents the mole % of compound VII used in the process; “c*” represents the mole % of compound VIII used in the process; and “d*” represents the mole % of compound IX used in the process.

When copolymers of formulae X, XI and XII are prepared in the process, as described in said first embodiment, preferably, a* is in the range 45-55, especially 48-52; and the sum of b*, c* and d* is in the range 45-55, especially 48-52.

Where copolymers of formulae XX, XXI, XXII and XXIII are prepared in the process, as described in said second embodiment, the sum of a* and d* is preferably in the range 45-52, especially 48-52; and the sum of b* and c* is preferably in the range 45-52, especially 48-52.

Where different compounds of formula IX are used, as described in the third embodiment, the sum of the mole % of the halogen-containing components is preferably in the range 45-52, especially 48-52; and the sum of the mole % of the -EH (or -E¹H if appropriate)—containing components is preferably in the range 45-52, especially 48-52.

Where copolymers of formula X, XI and XII are prepared, preferably b* is in the range 10-30; preferably, c* is in the range 2.5 to 40; ; and preferably, d* is in the range 2.5 to 40,. d* may be up to 100%, suitably up to 95%, preferably up to 90%, more preferably up to 85%, especially up to 80% of the sum of c*+d*.

In some cases, d* may be less than 30%, preferably less than 20%, more preferably less than 15%, especially less than 10% of the sum of c* and d*.

Where copolymers of formulae XX, XXI, XXII and XXIII are prepared in the process, a* may be in the range 25-52, especially 30-52; d* is in the range 2.5-40, especially 5-20; b* is in the range 12.5-30, and c* is in the range 2.5 to 40

The sum of a*, b*, c* and d* is suitably 100.

BM, SU and AM may independently be represented by any of the following formulae

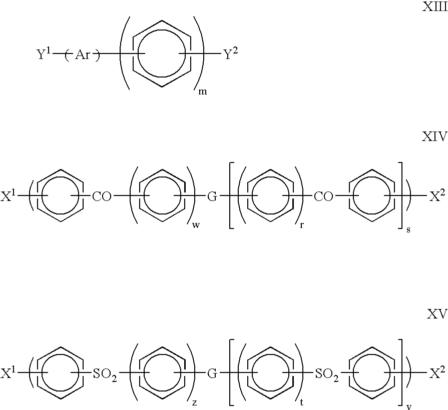

wherein Ar, m, w, r, s, z, t, v and G are as described in any statement herein.

XT may be represented by one of the following formulae

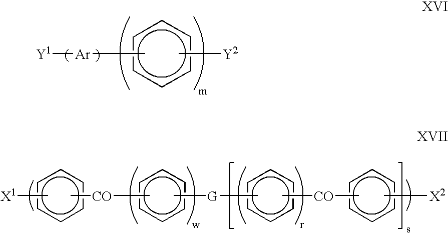

provided the unit is crystallisable as described above with respect to the selection of the second unit of formula IV or IV*.

In some situations, the polymer prepared, more particularly phenyl groups thereof, may be optionally substituted with the groups hereinabove described after polymer formation.

Preferred halogen atoms are fluorine and chlorine atoms, with fluorine atoms being especially preferred. Preferably, halogen atoms are arranged meta- or para- to activating groups, especially carbonyl groups.

The molecular weight of the copolymer can be controlled by using an excess of halogen or hydroxy reactants. The excess may typically be in the range 0.1 to 5.0 mole %. The polymerisation reaction may be terminated by addition of one or more monofunctional reactants as end-cappers.

The invention extends to a method of manufacturing a device selected from a fuel cell, electrolyser or gas diffusion electrode, the method including the step of using a semi-crystalline copolymer to prepare an ion-conducting element of the device.

The device is preferably a fuel cell and the element is preferably a polymer electrolyte membrane thereof.

Sulphonated polymers described herein may be made into films and/or membranes for use as PEMs by conventional techniques, for example as described in Examples 5 to 7 of U.S. Pat. No. 5,561,202.

Advantageously, sulphonated polymers may be dissolved in a solvent used to cast a film and/or membrane at relatively high temperature, for example at a temperature of greater than 100° C., preferably greater than 120° C., more preferably greater than 140° C., especially greater than 145° C. The use of relatively high temperatures may facilitate the manufacture of films.

Thus, the invention extends to method of making a film and/or a membrane, suitably for a fuel cell or electrolyser or any other use described herein, the method comprising contacting a polymer which includes ion-exchange sites (and is preferably a sulphonated polymer, especially as described herein) with a solvent wherein the temperature of the solvent is greater than 100° C., preferably greater than 120° C., more preferably greater than 140° C., especially greater than 145° C., whereby the polymer dissolves in the solvent and subsequently casting the solvent with dissolved polymer to make said film and/or membrane.

The sulphonated polymers described herein may be used as polymer electrolyte membranes in fuel cells or electrolysers as described. Additionally, they may be used in gas diffusion electrodes. The following further utilities for the membranes are also contemplated:

1. Proton exchange membrane based water electrolysis, which involves a reverse chemical reaction to that employed in hydrogen/oxygen electrochemical fuel cells.

2. Chloralkali electrolysis, typically involving the electrolysis of a brine solution to produce chlorine and sodium hydroxide, with hydrogen as a by-product.

3. Electrode separators in conventional batteries due to the chemical inertness and high electrical conductivity of the composite membranes.

4. Ion-selective electrodes, particularly those used for the potentiometric determination of a specific ion such as Ca²⁺, Na⁺, K⁺ and like ions. The composite membrane could also be employed as the sensor material for humidity sensors, as the electrical conductivity of an ion exchange membrane varies with humidity.

5. Ion-exchange material for separations by ion-exchange chromatography. Typical such applications are deionization and desalination of water (for example, the purification of heavy metal contaminated water), ion separations (for example, rare-earth metal ions, trans-uranium elements), and the removal of interfering ionic species.

6. Ion-exchange membranes employed in analytical preconcentration techniques (Donnan Dialysis). This technique is typically employed in analytical chemical processes to concentrate dilute ionic species to be analysed.

7. Ion-exchange membranes in electrodialysis, in which membranes are employed to separate components of an ionic solution under the driving force of an electrical current. Electrolysis applications include the industrial-scale desalination. of brackish water, preparation of boiler feed make-up and chemical process water, de-ashing of sugar solutions, deacidification of citrus juices, separation of amino acids, and the like.

8. Membranes in dialysis applications, in which solutes diffuse from one side of the membrane (the feed side) to the other side according to their concentration gradient. Separation between solutes is obtained as a result of differences in diffusion rates across the membrane arising from differences in molecular size. Such applications include hemodialysis (artificial kidneys) and the removal of alcohol from beer.

9. Membranes in gas separation (gas permeation) and pervaporation (liquid permeation) techniques.

10. Bipolar membranes employed in water splitting and subsequently in the recovery of acids and bases from waste water solutions.

Any feature of any aspect of any invention or example described herein may be combined with any feature of any aspect of any other invention or example described herein.

Specific embodiments of the invention will now be described, by way of example, with reference to FIG. 1 which is a schematic representation of a polymer electrolyte fuel cell.

The following abbreviations are used hereinafter

BP—4,4′-dihydroxybiphenyl

DHB—4,4′-dihydroxybenzophenone

Bis-S—4,4′-dihydroxydiphenylsulphone

2,4-DHB is 2,4-dihydroxybenzophenone

BDF—4,4′-difluorobenzophenone

Unless otherwise stated, all chemicals referred to hereinafter were used as received from Sigma-Aldrich Chemical Company, Dorset, U.K.

As described above, the fuel cell includes a thin sheet 2 of a hydrogen conducting Polymer Electrolyte Membrane.

The polymers for Polymer Electrolyte Membranes in accordance with embodiments of the invention are copolymers which include a first repeat unit which comprises a sulphonated polyarylether ketone (polyetherdiphenyletherketone). Because the unit is sulphonated, it will not be crystalline. In some cases, the first unit may be etherdiphenylethersulphone. The polymers include a second repeat unit which is crystalline. It includes ether and ketone units separated by phenyl groups. The ketone units can be interchanged with ether units in a crystal lattice so the polyetherketone units described are crystalline. The greater the extent of the polyaryetherketone chains, the greater the crystallinity of the copolymer. A third unit is included in the copolymer which is provided to reduce the level of crystallinity in the copolymer. The third unit includes units which cannot interchange with ether units in the crystal lattice and, therefore, disrupt the crystallinity of the second units.

In the following examples, Examples 1 and 4 are comparative examples. Example 1 describes the preparation of a copolymer using a mole ratio of BP:DHB of 1:1. Examples 2 and 3 show the effect of substituting some of the DHB with Bis-S. Example 4 describes the preparation of a copolymer using a mole ratio of BP:DHB of 1:2. Examples 5 and 6 show the effect of substituting some of the DHB with Bis-S and 2,4′-DHB respectively. Example 9a describes the preparation of a copolymer where the ratio of BP: (DHB+Bis-S) is 1:1.5 and the ratio of DHB:BIS-S is 40:60. Examples 9b-f describe the preparation of a copolymer where the ratio of BP:(DHB+Bis−S)is 1:1.5 and the ratio of DHB:Bis-S is varied.

### EXAMPLE 1 (COMPARATIVE)

A 700 flanged flask fitted with a ground glass Quickfit lid, stirrer/stirrer guide, nitrogen inlet and outlet was charged with 4,4′-difluorobenzophenone (89.03 g, 0.408 mole), 4,4′-dihydroxybiphenyl (37.24 g, 0.20 mole) 4,4′-dihydroxybenzophenone (42.84 g, 0.20 mole), and diphenysulphone (332 g) and purged with nitrogen for over 1 hour. The contents were then heated under a nitrogen blanket to between 140 and 150° C. to form an almost colourless solution. While maintaining a nitrogen blanket, dried sodium carbonate (43.24 g, 0.408 mole) was added. The temperature was raised gradually to 330° C. over 3 hours then maintained for 1 hours.

The reaction mixture was allowed to cool, milled and washed with acetone and water. The resulting polymer was dried in an air oven at 120° C. The polymer had a melt viscosity at 400° C., 1000 sec⁻¹ of 0.48 kNsm⁻².

### EXAMPLE 2

A 700 ml flanged flask fitted with a ground glass Quickfit lid, stirrer/stirrer guide, nitrogen inlet and outlet was charged with 4,4′-difluorobenzophenone (89.03 g, 0.408 mole), 4,4′-dihydroxybiphenyl (37.24 g, 0.20 mole), 4,4′-dihydroxydiphenylsulphone (10.01 g, 0.04 mole), 4,4′-dihydroxybenzophenone (34.28, 0.16 mole) and diphenysulphone (332 g) and purged with nitrogen for over 1 hour. The contents were then heated under a nitrogen blanket to between 140 and 150° C. to form an almost colourless solution. While maintaining a nitrogen blanket, dried sodium carbonate (43.24 g, 0.408 mole) was added. The temperature was raised gradually to 320° C. over 3 hours then maintained for 1.5 hours.

The reaction mixture was allowed to cool, milled and washed with acetone and water. The resulting polymer was dried in an air oven at 120° C. The polymer had a melt viscosity at 400° C., 1000 sec⁻¹ of 0.34 kNsm⁻².

### EXAMPLE 3

A 700 ml flanged flask fitted with a ground glass Quickfit lid, stirrer/stirrer guide, nitrogen inlet and outlet was charged with 4,4′-difluorobenzophenone (89.03 g, 0.408 mole), 4,4′-dihydroxybiphenyl (37.24 g, 0.20 mole), 4,4′-dihydroxydiphenylsulphone (15.02 g, 0.06 mole), 4,4′-dihydroxybenzophenone (29.99 g, 0.14 mole) and diphenysulphone (332g) and purged with nitrogen for over 1 hour. The contents were then heated under a nitrogen blanket to between 140 and 150° C. to form an almost colourless solution. While maintaining a nitrogen blanket, dried sodium carbonate (43.24 g, 0.408 mole) was added. The temperature was raised gradually to 320° C. over 3 hours then maintained for 1 hours.

The reaction mixture was allowed to cool, milled and washed with acetone and water. The resulting polymer was dried in an air oven at 120° C. The polymer had a melt viscosity at 400° C., 1000 sec⁻¹ of 0.42 KNsm⁻².

### EXAMPLE 4

A 700 ml flanged flask fitted with a ground glass Quickfit lid, stirrer/stirrer guide, nitrogen inlet and outlet was charged with 4,4′-difluorobenzophenone (89.03 g, 0.408 mole), 4,4′-dihydroxybiphenyl (24.83 g, 0.133 mole) 4,4′-dihydroxybenzophenone (57.41 g, 0.268 mole), and diphenysulphone (332 g) and purged with nitrogen for over 1 hour. The contents were then heated under a nitrogen blanket to between 140 and 150° C. to form an almost colourless solution. While maintaining a nitrogen blanket, dried sodium carbonate (43.24 g, 0.408 mole) was added. The temperature was raised gradually to 330° C. over 3 hours then maintained for 1 hours.

The reaction mixture was allowed to cool, milled and washed with acetone and water. The resulting polymer was dried in an air oven at 120° C. The polymer had a melt viscosity at 400° C., 1000 sec⁻¹ of 0.54 ksm⁻².

### EXAMPLE 5a

A 700 ml flanged flask fitted with a ground glass Quickfit lid, stirrer/stirrer guide, nitrogen inlet and outlet was charged with 4,4′-difluorobenzophenone (89.03 g, 0.408 mole), 4,4′-dihydroxybiphenyl (24.83 g, 0.133 mole), 4,4′-dihydroxydiphenylsulphone (13.35 g, 0.053 mole), 4,4′-dihydroxybenzophenone (45.7 g, 0.213 mole) and diphenysulphone (332 g) and purged with nitrogen for over 1 hour. The contents were then heated under a nitrogen blanket to between 140 and 150° C. to form an almost colourless solution. While maintaining a nitrogen blanket, dried sodium carbonate (43.24 g, 0.408 mole) was added. The temperature was raised gradually to 320° C. over 3 hours then maintained for 1.5 hours.

The reaction mixture was allowed to cool, milled and washed with acetone and water. The resulting polymer was dried in an air oven at 120° C. The polymer had a melt viscosity at 400° C., 1000 sec⁻¹ of 0.37 kNsm⁻².

### EXAMPLES 5b-5e AND 5f (COMPARATIVE)

The polymerisation procedure of Example 5a was followed, for 5b-5e, except that copolymers were prepared by varying the mole ratios of the hydroxy-containing reactants. The polymerisation procedure for 5f is described below.

A 700 ml flanged flask fitted with a ground glass Quickfit lid, stirrer/stirrer guide, nitrogen inlet and outlet was charged with 4,4′-difluorobenzophenone (89.03 g, 0.408 mole), 4,4′-dihydroxybiphenyl (24.83 g, 0.133 mole) 4,4′-dihydroxydiphenylsulphone (66.73 g, 0.267 mole), and diphenysulphone (332 g) and purged with nitrogen for over 1 hour. The contents were then heated under a nitrogen blanket to between 140 and 150° C. to form an almost colourless solution. While maintaining a nitrogen blanket, dried sodium carbonate (42.44 g, 0.4 mole) and potassium carbonate (1.11 g, 0.008 mole) were added. The temperature was raised gradually to 315° C. over 3 hours then maintained for 0.5 hours.

The reaction mixture was allowed to cool, milled and washed with acetone and water. The resulting polymer was dried in an air oven at 120° C. The polymer had a melt viscosity at 400° C., 1000 sec⁻¹ of 0.62 ksm⁻².

A summary of the mole ratios and MVs are detailed in the Table below. Example 5f is an amorphous equivalent of the other polymers.

| | |
|---|---|
| Polymercomposition (mole ratio) | MV |

| Example | BDF | BP | DHB | Bis-S | (kNsm⁻²) |
|---|---|---|---|---|---|
| 5a | 1.02 | 0.33 | 0.536 | 0.133 | 0.37 |
| 5b | 1.02 | 0.33 | 0.402 | 0.268 | 0.47 |
| 5c | 1.02 | 0.33 | 0.335 | 0.335 | 0.48 |
| 5d | 1.02 | 0.33 | 0.268 | 0.402 | 0.48 |
| 5e | 1.02 | 0.33 | 0.133 | 0.536 | 0.53 |
| 5f | 1.02 | 0.33 | — | 0.67 | 0.62 |

### EXAMPLE 6a

A 700 ml flanged flask fitted with a ground glass Quickfit lid, stirrer/stirrer guide, nitrogen inlet and outlet was charged with 4,4′-difluorobenzophenone (89.03 g, 0.408 mole) 4,4′-dihydroxybiphenyl (24.83 g, 0.133 mole), 2,4-dihydroxybenzophenone (11.42 g, 0.053 mole), 4,4′-dihydroxybenzophenone (45.7 g, 0.213 mole) and diphenysulphone (332 g) and purged with nitrogen for over 1 hour. The contents were then heated under a nitrogen blanket to between 140 and 150° C. to form an almost colourless solution. While maintaining a nitrogen blanket, dried sodium carbonate (43.24 g, 0.408 mole) was added. The temperature was raised gradually to 320° C. over 3 hours then maintained for 1.5 hours.

The reaction mixture was allowed to cool, milled and washed with acetone and water. The resulting polymer was dried in an air oven at 120° C. The polymer had a melt viscosity at 400° C., 1000 sec⁻¹ of 0.80 kNsm⁻².

### EXAMPLE 6b

The polymerisation procedure of Example 6a was followed except that a copolymer was prepared with a different mole ratio of the hydroxy-containing reactants. A summary of the mole ratios and MVs for Examples 6a and 6b are detailed in the Table below.

| | Polymer Composition (mole ratio) | | | | MV |
|---|---|---|---|---|---|
| Example | BDF | BP | 4,4′-DHB | 2,4-DHB | (kNsm⁻²) |
| 6a | 1.02 | 0.33 | 0.533 | 0.133 | 0.70 |
| 6b | 1.02 | 0.33 | 0.402 | 0.268 | 0.38 |

### EXAMPLE 7

### General Sulphonation Procedure

The polymers of Examples 1-6 were sulphonated by stirring each polymer in 98% sulphuric acid (3.84 g polymer/100 g sulphuric acid) for 21 hours at 50° C. Thereafter, the reaction solution was allowed to drip into stirred deionised water. Sulphonated polymer precipitated as free-flowing beads. Recovery was by filtration, followed by washing with deionised water until the pH was neutral and subsequent drying. In general, titration confirmed that 100 mole % of the biphenyl units had sulphonated, giving one sulphonic acid group, ortho to the ether linkage, on each of the two aromatic rings comprising the biphenyl unit.

### EXAMPLE 8a

### Membrane Fabrication

Membranes were produced from the polymers from Examples 1 to 6 after sulphonation as described in Example 7 by dissolving respective polymers in N-methylpyrrolidone (NMP). The polymers were dissolved at 80° C. at their maximum concentration as shown in the Table below. In one example, a 50:50 w/w blend of the polymers described in Examples 5d and 5e, sulphonated as described in Example 7, was used to prepare a membrane.

The homogeneous solutions were cast onto clean glass plates and then drawn down to give 400 micron films, using a Gardner Knife. The solvent was then evaporated at 100° C. under vacuum for 24 hours.

### EXAMPLE 8b

### Boiling Water Uptake

The following general procedure was followed to determine the Boiling Water Uptake.

5 cm×5 cm×50 microns samples of membranes were separately immersed in boiling deionised water (500 ml) for 60 mins, removed and dried quickly with lint-free paper to remove surface water, weighed, dried in an oven at 50° C. for 1 day, allowed to cool to ambient temperature in a desiccator then weighed quickly. The % water-uptake was calculated as described below:

$$\% Water \text{-} uptake = \frac{Wet Weight - Dry Weight}{Dry Weight} \times 100$$

Results for membranes assessed are provided in the table below.

| Sulphonated | | Measured | | Boiling |
|---|---|---|---|---|
| polymer | | EW | | Water |
| from | Theoretical | (by | Concentration | Uptake |
| Example* | EW | titration) | in NMP (% w/w) | (%) |
| 1 | 458 | 472 | 4 | 237 |
| 2 | 462 | 483 | 7.5 | 300 |
| 3 | 464 | | 10 | 320 |
| 4 | 654 | 674 | Insoluble | — |
| 5a | 657 | 670 | 5 | 69 |
| 5b | 663 | 667 | 7.5 | 77 |
| 5c | 670 | 671 | 7.5 | 81 |
| 5d | 676 | 685 | 10 | 90 |
| 5e | 683 | 660 | 15 | 172 |
| 5f | 690 | 663 | 15 | 165 |
| 6a | 647 | 666 | 5 | 73 |
| 6b | 655 | 671 | 10 | 100 |
| 50:50 w/w | 680 | | 15 | 128 |
| blend of | | | | |
| polymers | | | | |
| from | | | | |
| Examples 5d | | | | |
| and 5e | | | | |

*It should be appreciated that the polymers of the referenced Examples are sulphonated as described in Example 7.

It will be noted from the above Table that Example 1 has relatively low solubility in NMP and this is believed to be due to the crystallinity caused by the PEK units in lo the copolymer. It will, however, be noted from Examples 2 and 3 that the inclusion of Bis-S reduces the crystallinity. This is believed to be due to the fact that Bis-S has a shape and/or conformation which is incompatible with the crystalline regions of the copolymer (ie the PEK unit) and, accordingly, it disrupts the PEK chains, thereby lowering crystallinity. However, the level of water absorption may not be detrimentally increased. As the level of Bis-S is increased, the level of crystallinity is reduced further (compare Examples 2 and 3). Examples 4 to 6 may be interpreted as for Examples 1 to 3.

### EXAMPLE 8c

### Determination of the Crystallinity Index Values or Sulphonated Polymers from Example 5b, 5d and 5f by wide Angle X-Ray Scattering (WAXS)

Crystallinity can be quantified, in one method, by defining a “crystallinity index” for measurements made by Wide Angle X-ray Scattering (WAXS). This approach defines the measurement in relation to the WAXS pattern. The measured area of crystalline peaks in the WAXS pattern is taken as a percentage of the total crystalline and amorphous scatter over a chosen angular range of the pattern. Crystallinity index should, to a first approximation, be proportional to crystallinity for broadly similar polymer materials. It is constrained to be zero when crystallinity is zero and 100% when crystallinity is 100%.

Membranes of the sulphonated polymers from Examples 5b, 5d and 5f as prepared in Example 8a were examined by WAXS as described below.

The membranes were analysed using a Siemens D5000 X-ray diffractometer with Cu K-alpha radiation and a Kevex energy dispersive detector. Measurements were made from a single membrane sheet mounted in symmetrical reflection geometry. A programmable divergence slit was used to maintain a constant irradiated region of the specimen surface 6 mm long over a 2-theta measurement range of 10-49°.

The WAXS pattern of the membrane from Example 5f exhibited only broad amorphous scatter, whereas the patterns of the membranes from Examples 5b and 5d exhibited sharper, crystalline peaks in addition to amorphous bands. The intensity of the bands for Example 5b was greater than for Example 5d.

The measured WAXS patterns were analysed by first making a background correction, subtracting the corresponding WAXS pattern from a blank specimen holder. The resulting patterns were fitted by a combination of a pattern measured from a similar but amorphous membrane film and a set of peaks (at approximately 18.8, 20.8, 22.9, 29.1 and 40.0° 2-theta) corresponding to those observed in the more crystalline membranes. The crystallinity index was calculated as the total area fitted by these peaks taken as a percentage of the combined area of the fitted peaks and the fitted amorphous pattern.

The results are detailed in the Table below.

| Sulphonated | |
|---|---|
| polymer | Crystallinity |
| from Example | Index (%) |
| 5f | 0 |
| 5d | 2.1 |
| 5b | 7.1 |

### EXAMPLE 9a

A 700 ml flanged flask fitted with a ground glass Quickfit lid, stirrer/stirrer guide, nitrogen inlet and outlet was charged with 4,4′-difluorobenzophenone (89.03 g, 0.408 mole), 4,4′-dihydroxybiphenyl (29.79 g, 0.16 mole), 4,4′-dihydroxydiphenylsulphone (36.04 g, 0.144 mole), 4,4′-dihydroxybenzophenone (20.57 g, 0.096 mole) and diphenysulphone (332 g) and purged with nitrogen for over 1 hour. The contents were then heated under a nitrogen blanket to between 140 and 150° C. to form an almost colourless solution. While maintaining a nitrogen blanket, dried sodium carbonate (43.24 g, 0.408 mole) was added. The temperature was raised gradually to 320° C. over 3 hours then maintained for 1.5 hours.

The reaction mixture was allowed to cool, milled and washed with acetone and water. The resulting polymer was dried in an air oven at 120° C. The polymer had a melt viscosity at 400° C., 1000 sec⁻¹ of 0.6 kNsm⁻².

### EXAMPLE 9b-9e AND 9f (COMPARATIVE)

The polymerisation procedure of Example 9a was followed, except that copolymers were prepared by varying the mole ratios of the hydroxy-containing reactants. A summary of the mole ratios and the MVs are detailed in the Table below.

| | |
|---|---|
| Polymer composition (mole ratio) | MV |

| Example | BDF | BP | DHB | Bis-S | (kNsm⁻²) |
|---|---|---|---|---|---|
| 9a | 1.02 | 0.4 | 0.24 | 0.36 | 0.6 |
| 9b | 1.02 | 0.4 | 0.36 | 0.24 | 0.21 |
| 9c | 1.02 | 0.4 | 0.39 | 0.21 | 0.32 |
| 9d | 1.02 | 0.4 | 0.42 | 0.18 | 0.44 |
| 9e | 1.02 | 0.4 | 0.6 | — | 0.45 |
| 9f | 1.02 | 0.4 | — | 0.6 | 0.26 |

### EXAMPLE 10a

### Sulphonation and Subsequent Dissolution of Polymer from Example 9a

The polymer from Example 9a was sulphonated as described in Example 7 and dissolved in NMP at 15% w/w at two different temperatures, 80° and 150° C. The sulphonated polymers from both thermal treatments were completely soluble producing homogeneous solutions, filtered through a 10 micron filter, cast on to clean glass plates and drawn down to give 400 micron films, using a Gardner Knife. The solvent was evaporated at 100° C. under vacuum for 24 hours.

The effect of the two thermal treatments on the sulphonated polymer was investigated by evaluating the following:

Reduced Viscosity (RV): measured at 25° C. on a solution of the polymer in NMP, the solution containing 1 g of polymer/100 cm³ of solution.

Gel Permeation Chromatography (GPC): Triple Detector GPC using DMSO as the solvent with the addition of 0.05% lithium chloride

Ion Exchange Capacity (IEC): titration

Boiling Water Uptake: as described in Example 8b

| | Sulphonated | Sulphonated |
|---|---|---|
| | Polymer | Polymer |
| | dissolved at | dissolved at |
| Test | 80° C. | 150° C. |
| RV | 1.22 | 1.22 |
| GPC | | |
| Mn | 28700 | 24800 |
| MW | 47600 | 47000 |
| PDI | 1.7 | 1.9 |
| Ion Exchange | 1.72 | 1.72 |
| Capacity (meq/g) | | |
| Boiling Water | 550 | 570 |
| Uptake (%) | | |

It will be appreciated from the above that, contrary to expectations, there does not appear to be any detriment in dissolving the sulphonated polymer at a high temperature (e.g. 150° C.).

### EXAMPLES 10b-f

### Sulphonation and Subsequent Dissolution of Polymers from Examples 9b-f

The polymers from Examples 9b-f respectively were sulphonated as described in Example 7, dissolved in NMP at 150° C., filtered through a 10 micron filter, cast on to clean glass plates and drawn down, using a Gardner Knife. The solvent was evaporated at 100° C. under vacuum for 24 hours producing membranes of mean thickness of 40 microns.

The boiling water uptake was determined as described in Example 8a. The results are detailed in the Table below.

| | | Boiling | | |
|---|---|---|---|---|
| Sulphonated | | Water | | Measured |
| polymer from | Concentration | Uptake | Theoretical | EW (by |
| Example | in NMP (% w/w) | (%) | EW | titration) |
| 10a | 15 | 550 | 564 | 564 |
| 10b | 10 | 190 | 559 | 564 |
| 10c | 10 | 135 | 558 | 571 |
| 10d | 10 | 109 | 557 | 591 |
| 10e | 8 | 82 | 550 | 572 |
| 10f | 15 | 520 | 583 | 602 |

### EXAMPLE 11a

### Comparison of Fuel Cell Performance of Example 10c, Example 10f and Nafion 115 (a Commercially Available Material)

The membrane of Example 10c and 10f were pre-treated by boiling in 1M sulphuric acid, allowed to cool to room temperature followed by thorough washing with deionised water. Membrane Electrode Assemblies (MEA) were prepared using standard platinum loaded, Nafion® impregnated Gas Diffusion Electrodes (E-Tek, Elat 0.35 mg pt cm⁻²) hot pressed onto the membrane. The active area being 11.8 cm². The following operating conditions were followed:

| | |
|---|---|
| Hydrogen Pressure | 3 Barg |
| Air Pressure | 3 Barg |
| Hydrogen Stoichiometry | 1.5 |
| Air Stoichiometry | 3 |
| Cell Temperature | 60° C. |
| Current Density | 0.7 Acm⁻² |

The comparative voltages at current density of 0.8 cm⁻² for the unreinforced and reinforced membranes were 0.64 and 0.6V respectively and for Naf ion 115, the voltage was 0.4V.

The MEA using the membrane from Example 10f was very fragile and required very careful handling, whereas the membrane from Example 10c was robust.

### EXAMPLE 11b

### Determination of the Crystallinity Index Values of Sulphonated Polymers from Examples 9c and 9f by WAXS

Membranes of the sulphonated polymers from Examples 9c and 9f as prepared in Example 8a were examined by WAXS as described in the Example 8c.

The WAXS pattern of the membrane from Example 9f exhibited only broad amorphous scatter, whereas the patterns of the membranes from Examples 9c exhibited sharper, crystalline peaks in addition to amorphous bands.

The results are detailed in the Table below.

| Sulphonated | Crystallinity |
|---|---|
| polymer | Index |
| from Example | (%) |
| 9f | 0 |
| 9c | 6 |

### EXAMPLE 12

### Blends with Polyethersulphone

Sulphonated polymer from Example 5d and polyethersulphone were dissolved in N-methylpyrrolidone (NMP) at concentrations shown in the Table below. The homogeneous solutions were cast onto clean glass plates and then drawn down to give 400 micron films, using a stainless steel Gardner Knife. Evaporation at 100° C. under vacuum for 24 hours produced membranes of mean thickness 40 microns.

The boiling water uptake of these membranes was determined as described in Example 8b. The results are detailed in the Table below.

| Sulphonated | | Boiling |
|---|---|---|
| Polymer from | | Water |
| Example 5d | polyethersulphone | Uptake |
| % w/w | % w/w | (%) |
| 15 | 0 | 102 |
| 14.25 | 0.75 | 125 |
| 13.5 | 1.5 | 105 |

### EXAMPLE 13

### Blend with Polyethersulphone

The procedure of Example 12 was followed except that sulphonated polymer from Example 9d was used instead of that from Example 5d. Results for the boiling water uptake are detailed in the table below.

| Sulphonated | | Boiling |
|---|---|---|
| Polymer from 9d | Polyethersulphone | Water |
| (% w/w) | (% w/w) | Uptake (%) |
| 15 | 0 | 109 |
| 14.25 | 0.75 | 84 |
| 13.5 | 1.5 | 74 |
| 12.75 | 2.25 | 69 |
| 12.0 | 3.0 | 49 |

### EXAMPLE 14

A 250 ml 3-necked, round-bottomed fitted with a stirrer/stirrer guide, nitrogen inlet and outlet was charged with 4,4′-difluorobenzophenone (11.36 g, 0.052 mole), 4,4′-bis (4-chlorophenylsulphonyl)biphenyl (LCDC) (25.17 g, 0.05 mole), 4,4′-dihydroxybiphenyl (6.21 g, 0.0333 mole), 4,4′-dihydroxybenzophenone (14.28 g, 0.0667 mole), and diphenysulphone (90 g) and purged with nitrogen for over 1 hour. The contents were then heated under a nitrogen blanket to between 140 and 150° C. to form an almost colourless solution. While maintaining a nitrogen blanket, dried sodium carbonate (10.6 g, 0.1 mole) and potassium carbonate (0.28 g, 0.002 mole) were added. The temperature was raised gradually to 315° C. over 3 hours then maintained for 1 hour.

The reaction mixture was allowed to cool, milled and washed with acetone and water. The resulting polymer was dried in an air oven at 120° C. The polymer had a melt viscosity at 400° C., 1000 sec⁻¹ of 0.18 kNsm⁻².

### EXAMPLE 15

A 250 ml 3-necked, round-bottomed fitted with a stirrer/stirrer guide, nitrogen inlet and outlet was charged with 4,4′-difluorobenzophenone (11.02 g, 0.0505 mole), 4,4′-dichlorodiphenylsulphone (14.36 g, 0.05 mole), 4,4′-dihydroxybiphenyl (6.21 g, 0.0333 mole), 4,4′-dihydroxybenzophenone (14.28 g, 0.0667 mole), and diphenysulphone (83 g) and purged with nitrogen for over 1 hour. The contents were then heated under a nitrogen blanket to between 140 and 150° C. to form an almost colourless solution. While maintaining a nitrogen blanket, dried sodium carbonate (10.60 g, 0.1 mole) and potassium carbonate (0.28 g, 0.002 mole) were added. The temperature was raised gradually to 315° C. over 3 hours then maintained for 140 minutes.

The reaction mixture was allowed to cool, milled and washed with acetone and water. The resulting polymer was dried in an air oven at 120° C. The polymer had a melt viscosity at 400° C., 1000 sec⁻¹ of 0.39 kNsm⁻².

### EXAMPLE 16

### Sulphonation of and Subsequent Dissolution and Membrane Fabrication of Polymers from Examples 14 and 15

The polymers from Examples 14 and 15 were sulphonated as described in Example 7 and dissolved in NMP at 15% w/w at 80° C. and room temperature respectively. The homogeneous solutions were filtered through a 10 micron filter, cast on to clean glass plates and drawn down to give 400 micron films, using a Gardner Knife. The solvent was evaporated at 100° C. under vacuum for 24 hours. The boiling water uptake was 39 and 108% for the sulphonated polymer from Example 14 and 15 respectively, determined as described in Example 8b.

As an alternative to Bis-S, (or 2,4-DHB) other moieties may be incorporated into the copolymer. Some examples are as follows. It will be noted that all of the examples shown are unsymmetrical about an imaginary line which passes through the two —OH— groups. Whilst 4,4′-dihydroxybenzophenone is unsymmetrical in the manner described, the carbonyl moiety can be interchanged with an ether moiety in a crystal structure so that polymeric chains containing ketone and ether groups are crystallisable. In contrast, an —SO₂ — moiety cannot be interchanged with an ether moiety so —SO₂ — moieties act to disrupt chains and reduce crystallinity.

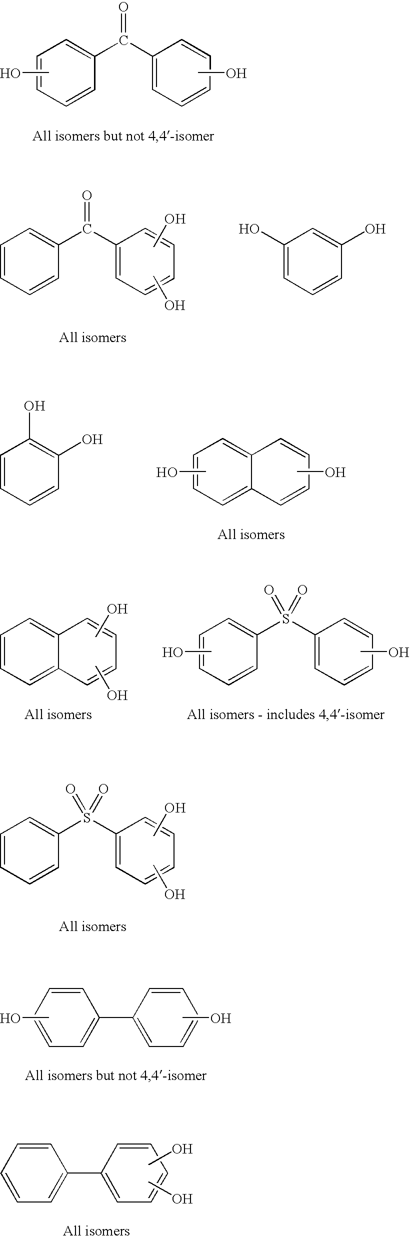

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment (s). The invention extend to any novel one, or any novel combination, of the features disclosed in this specification (including any accompanying claims, abstract and drawings), or to any novel one, or any novel combination, of the steps of any method or process so disclosed.

1. A polymer electrolyte membrane or a gas diffusion electrode which include a semi-crystalline copolymer comprising:
a first unit which includes an ion-exchange site;
a second crystalline unit; and
a third unit which is amorphous.

2. A polymer electrolyte membrane which includes a semi-crystalline copolymer comprising:
a first unit which includes an ion-exchange site;
a second crystalline unit; and
a third unit which is amorphous.

3. A membrane or electrode according to claim 1 or claim 2, wherein the level of crystallinity in said copolymer is at least 0.5%.

4. A membrane or electrode according to any preceding claim, wherein said first unit is a repeat unit which includes aromatic group containing moieties linked by —SO₂— and/or —CO— and/or -Q- groups, where Q is O or S.

5. A membrane or electrode according to any preceding claim, wherein said second unit is a repeat unit which includes aromatic group containing moieties linked by —CO— and/or -Q- groups, where Q is O or S.

6. A membrane or electrode according to any preceding claim, wherein said third unit is a repeat unit which includes aromatic group containing moieties linked by —SO₂— and/or —CO— and/or -Q- groups, where Q is O or S provided, however, that said third unit suitably includes a means to render it amorphous (hereinafter said “amorphous means”) and/or not crystallisable with polyarylether ketones or polyarylthioether ketones and/or not crystallisable with the second unit described above.

7. A membrane or electrode according to any preceding claim, wherein said third unit comprises a fourth unit which is of formula -Q-Z-Q- wherein Z represents said aromatic group containing moiety, wherein said fourth unit is not symmetrical about an imaginary line which passes through the two -Q- moieties provided, however, that said fourth unit is not derived from dihydroxybenzophenone substituted by groups Q at the 4- and 4′-positions.

8. A membrane or electrode according to any preceding claim, wherein said copolymer includes a first unit which is of general formula 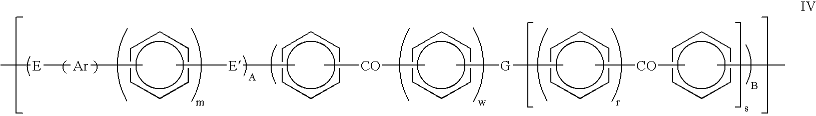
or of general formula 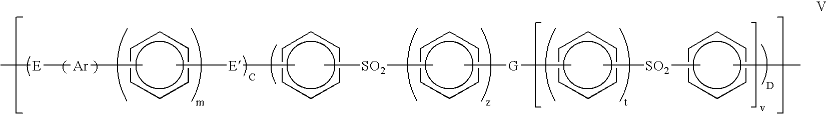
or of general formula 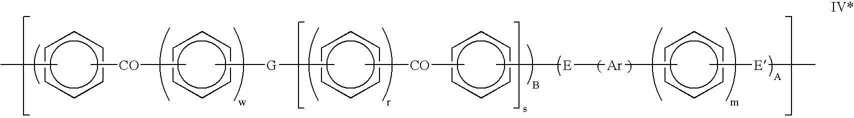
or of general formula 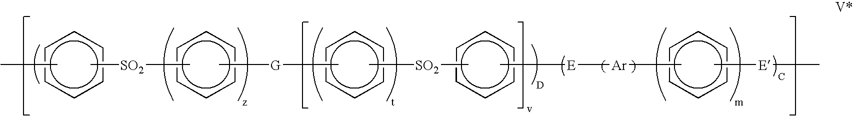
wherein said first unit is functionalised to provide ion-exchange sites; wherein the phenyl moieties in units IV, IV*, V and V* are independently optionally substituted wherein m,r,s,t,v,w and z independently represent zero or a positive integer, E and E′ independently represent an oxygen or a sulphur atom or a direct link, G represents an oxygen or sulphur atom, a direct link or a —O-Ph-O— moiety where Ph represents a phenyl group and Ar is selected from one of the following moieties (i)* and (i) to (x) which is bonded via one or more of its phenyl moieties to adjacent moieties

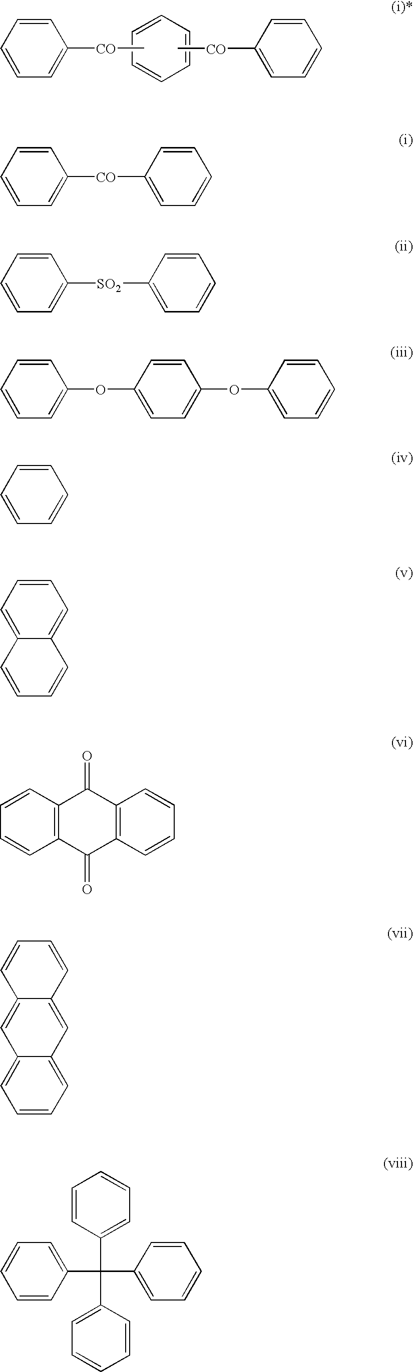

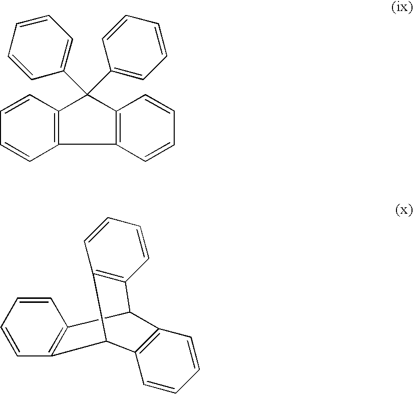

9. A membrane or electrode according to any preceding claim, wherein said first unit is sulphonated to provide said ion-exchange site.

10. A membrane or electrode according to any preceding claim, wherein said first unit includes a multi-phenylene moiety or fused ring aromatic moiety which is functionalised to provide said ion-exchange site.

11. A membrane or electrode according to any preceding claim, wherein said first unit includes a —O-biphenylene-O— or —O-naphthalene-O— moiety.

12. A membrane or electrode according to any preceding claim, wherein said second crystalline unit is of general formula IV or IV* as described in claim 8, provided said unit is crystalline.

13. A membrane or electrode according to any preceding claim, wherein said third unit is of general formula IV, IV*, V or V* provided said unit is amorphous.

14. A membrane or electrode according to any preceding claim, wherein said first unit is selected from -ether-phenyl-ketone-phenyl, -ether-phenyl-ketone-phenyl-ether-phenyl-ketone-phenyl-ketone-phenyl, -ether-biphenyl-ether-phenyl-ketone-phenyl, -ether-phenyl-ether-phenyl-ketone-phenyl, -ether-naphthalene-ether-phenyl-ketone-phenyl, -ether-phenyl-ether-phenyl-ketone-phenyl-ketone-phenyl, -ether-diphenyl-ether-phenyl-sulphone-phenyl, -ether-phenyl-ether-phenyl-sulphone-phenyl and ether-phenyl-sulphone-phenyl.

15. A membrane or electrode according to any preceding claim, wherein said second unit is selected from ether-phenyl-ketone-phenyl-ketone-phenyl-, ether-phenyl-ether-phenyl-ketone-phenyl-ketone-phenyl-, ether-phenyl-ether-phenyl-ketone-phenyl-, ether-phenyl-ketone-phenyl-, ether-phenyl-ketone-phenyl-ether-phenyl-ketone-phenyl-ketone-phenyl and ether-biphenyl-ether-phenyl-ketone-phenyl-.

16. A membrane or electrode according to any preceding claim, wherein said third unit is selected from ether-phenyl-sulphone-phenyl, ether-phenyl-ether-phenyl-sulphone-phenyl and a 1,3-dioxy-4-(phenylcarbonyl)phenyl moiety.

17. A device selected from a fuel cell, electrolyser or gas diffusion electrode, the device incorporating a semi-crystalline copolymer according to any preceding claim.

18. A method of manufacturing a device selected from a fuel cell, electrolyser or gas diffusion electrode, the method including the step of using a semi-crystalline copolymer to prepare an ion-conducting element of the device.

19. A process for the preparation of a semi-crystalline copolymer as described in any of claims 1 to 16, the process comprising polycondensing a compound of formula
X¹—BM-X² XVI
with a compound of formula
Y¹—SU—Y² XVII
and with a compound of formula
Y¹—XT-Y² XVIII
and with a compound of formula
Z¹-AM-Z² XIX
thereby to prepare a copolymer, wherein Y¹ represents a halogen atom or a group -EH (or -E′H if appropriate) and X¹ represents the other one of a halogen atom or group -EH (or -E′H if appropriate), Y² represents a halogen atom or a group -E′H and X² represents the other one of a halogen atom or a group -E′H (or -EH if appropriate) and Z¹ and Z² represent a halogen atom or a group -EH (or E′H if appropriate);
and wherein BM represents part of a base monomer, SU represents part of a moiety which is functionalised or can be functionalised (suitably independently of other moieties in the copolymer) to provide ion-exchange sites, XT represents a part of a crystalline or crystallisable moiety and AM represents part of an amorphous moiety.
